(19) United States
(12) Patent Application Publication
(10) Pub. No.: US 2025/0055965 A1
(43) Pub. Date: Feb. 13, 2025

(54) IMAGE COLOR DISPLAY RESTORATION SYSTEM, METHOD AND DISPLAY SYSTEM

(71) Applicant: AUO Display Plus Corporation, Hsinchu City (TW)

(72) Inventors: WEI-CHOU KUO, Hsinchu City (TW); Chin Jung Yeh, Hsinchu City (TW); PO-KUN CHEN, Hsinchu City (TW); YUJEN HSU, Hsinchu City (TW)

(21) Appl. No.: 18/931,142

(22) Filed: Oct. 30, 2024

(30) Foreign Application Priority Data
Feb. 22, 2024 (TW) 113106324
Apr. 15, 2024 (CN) 202410449605.2

(51) Int. Cl. H04N 9/64; A61C 13/00; F21V 11/00; G06F 3/14; G06T 7/80; G06T 7/90; H04N 9/77; H04N 23/74

(52) U.S. Cl. CPC H04N 9/646; A61C 13/0004; G06F 3/14; G06T 7/80; G06T 7/90; H04N 9/77; H04N 23/74; F21V 11/00; G06T 2207/10024; G06T 2207/30036

(57) ABSTRACT

An image color display restoration system, method and display system include a first auxiliary light source; a camera device connected to the first auxiliary light source to form an imaging environment, acquiring a first image and imaging parameter values in the imaging environment, wherein the first image includes an image of a colorimetric component; a display device located in an ambient light source area having a first illumination value, and receiving and displaying a second image, wherein the display device has display parameter values; a second auxiliary light source matched and arranged corresponding to the display device and forming a light source control area, and having a second illumination value; a cloud platform receiving the first image, the imaging parameter values and the display parameter values, and after correcting the first image according to the imaging parameter values and the display parameter values, outputting the second image.

### FIELD OF THE INVENTION

The present invention relates to a color display system and method, and in particular to an image color display restoration system, method and display system.

### BACKGROUND OF THE INVENTION

When a denture is completed but does not fit smoothly into the patient's mouth, the dentist, the patient and the dental technician will start to try it on again and again to correct and adjust the same denture. This result will affect the profits of dentists and dental laboratories with the increase of time cost, and may even reduce patients' trust in dental clinics. In practice, the return caused by wrong color costs a lot of time for the dentist, the dental technician or the patient, and especially for the dental laboratory, it also increases the manufacturing cost.

### SUMMARY OF THE INVENTION

By researching the capturing, transmission, image correction, and correct restoration and display of colorimetric photos, image applications across the two fields (dental clinics and dental laboratories) focus on image management, transmission and communication between doctors and dental technicians, so that the solutions proposed by the present invention that combine related technologies such as color correction, colorimetric algorithm, cloud technology and software technology can completely solve the problems of color display errors and contrast errors (collectively referred to as color difference) between the fields described above.

An image color display restoration system provided by the present invention includes: a colorimetric component, having a plurality of color blocks and a hueless color block; a first auxiliary light source; a camera device, connected to the first auxiliary light source to form an imaging environment, the camera device acquiring a first image and an imaging parameter value in the imaging environment, and the first image including an image of the colorimetric component; a display device, located in an ambient light source area having a first illumination value, the display device having a display parameter value; a second auxiliary light source, matched and arranged corresponding to the display device and forming a light source control area, the second auxiliary light source having a second illumination value, and the second illumination value being greater than or equal to 2 times the first illumination value; and a cloud platform, coupled to the camera device and the display device, and configured to receive the first image, the imaging parameter value and the display parameter value, and after correcting the first image according to the imaging parameter value and the display parameter value, output a second image. The display device receives and displays the second image.

In an embodiment of the present invention, the light source control area is located in front of a display surface of the display device.

In an embodiment of the present invention, the first image includes a physical object image.

In an embodiment of the present invention, the second image includes an image color temperature value. The image color temperature value is the same as a color temperature value of the second auxiliary light source.

In an embodiment of the present invention, the second auxiliary light source includes a light shield and a light-emitting component, and the light-emitting component is matched and assembled corresponding to the light shield.

In an embodiment of the present invention, the light shield is arranged around the display device and extends to the front of the display surface of the display device.

In an embodiment of the present invention, the light-emitting component is arranged in the light shield and located above the display device to form the light source control area. Light in the light source control area has an included angle with the display surface of the display device.

In an embodiment of the present invention, the included angle is 60° to 90°.

In an embodiment of the present invention, the imaging parameter value further includes a color temperature value.

In an embodiment of the present invention, the display parameter value includes a display Gamma value, a display contrast value and a display brightness value.

In an embodiment of the present invention, a display panel of the display device includes a diffused reflection film.

In an embodiment of the present invention, the hueless color block is a gray color, and the gray color has the following Lab values: a lightness of 70 to 90, a red/green value of ±1.5, and a blue/yellow value of ±1.5.

A display system provided by the present invention includes: a display device, located in an ambient light source area having a first illumination value; and a second auxiliary light source, matched and arranged corresponding to the display device and forming a light source control area, the second auxiliary light source having a second illumination value. The second illumination value in the light source control area is more than 2 times the first illumination value.

In an embodiment of the present invention, the second auxiliary light source includes a light shield and a light-emitting component, and the light-emitting component is matched and assembled corresponding to the light shield.

In an embodiment of the present invention, the light shield is arranged around the display device and extends to the front of the display surface of the display device.

In an embodiment of the present invention, the light-emitting component is arranged in the light shield and located above the display device to form the light source control area. Light in the light source control area incident to the display surface of the display device forms an included angle.

In an embodiment of the present invention, the included angle is 60° to 90°.

An image color display restoration system provided by the present invention includes: a display device, having a display parameter value; and a cloud platform, receiving a first image, an imaging parameter value and the display parameter value, and after correcting the first image according to the imaging parameter value and the display parameter value, outputting a second image. The display device receives and displays the second image under the display parameter value, the first image includes a physical object image and an image of a colorimetric component, and the image of the colorimetric component includes at least one color block image and a hueless color block image.

In an embodiment of the present invention, the hueless color block image is a gray color, and the gray color has the following Lab values: a lightness of 70 to 90, a red/green value of ±1.5, and a blue/yellow value of ±1.5.

In an embodiment of the present invention, the display parameter value and the imaging parameter value both include parameter data of the image of the colorimetric component.

In an embodiment of the present invention, the image color display restoration system further includes a first auxiliary light source. The imaging parameter value includes a color temperature value of the first auxiliary light source.

In an embodiment of the present invention, the image color display restoration system further includes a second auxiliary light source, and the second auxiliary light source has a second illumination value.

In an embodiment of the present invention, the second auxiliary light source is matched and arranged corresponding to the display device and forms a light source control area.

In an embodiment of the present invention, the image color display restoration system includes an ambient light source area having a first illumination value and matched and arranged corresponding to the display device. The first illumination value is smaller than ½ of the second illumination value.

An image color display restoration method provided by the present invention includes: providing a camera device and a first auxiliary light source to acquire a first image, and outputting the first image and an imaging parameter value of the camera device, the first image including an image of a colorimetric component; providing a display device, and outputting a display parameter value; providing a cloud platform to receive the first image, the imaging parameter value and the display parameter value, and correcting the first image according to the first image, the imaging parameter value and the display parameter value and outputting a second image; providing a second auxiliary light source; and receiving the second image by the display device, and displaying the second image on the display device by using the second auxiliary light source.

In an embodiment of the present invention, the image color display restoration method further includes: capturing a correction image by the camera device with the first auxiliary light source to generate the imaging parameter value of the camera device.

In an embodiment of the present invention, the image color display restoration method further includes: providing a display correction image; and receiving, by the display device, the display correction image, and generating the display parameter value.

In an embodiment of the present invention, the image color display restoration method further includes: providing an imaging environment, the imaging environment including the camera device and the first auxiliary light source, and the camera device acquiring the first image and the imaging parameter value in the imaging environment.

In an embodiment of the present invention, the image color display restoration method further includes: providing an ambient light source area, the display device being located in the ambient light source area, and the ambient light source area having a first illumination value.

In an embodiment of the present invention, the image color display restoration method further includes: providing a light source control area, the second auxiliary light source being matched and arranged corresponding to the display device to form the light source control area, the second auxiliary light source having a second illumination value, and the second illumination value being greater than or equal to 2 times the first illumination value.

In an embodiment of the present invention, the light source control area is located in front of a display surface of the display device.

In an embodiment of the present invention, the first image includes a physical object image.

In an embodiment of the present invention, the second image includes an image color temperature value. The image color temperature value is the same as a color temperature value of the second auxiliary light source.

In an embodiment of the present invention, the imaging parameter value further includes a color temperature value.

In an embodiment of the present invention, the display parameter value includes a display Gamma value, a display contrast value and a display brightness value.

By means of parameter correction and setting with the colorimetric component, the auxiliary light sources, the camera device and the display device, the color can be automatically corrected, and the color difference of the denture can be reduced, and the color accuracy of the denture can be improved.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a block diagram of an image color display restoration system provided by an embodiment of the present invention;

FIG. 2 is a schematic view of an imaging environment provided by an embodiment of the present invention;

FIG. 3 is a schematic view of a second auxiliary light source provided by an embodiment of the present invention;

FIG. 4 is a side view of the second auxiliary light source provided by an embodiment of the present invention;

FIG. 5 is a schematic diagram of an image color display restoration method provided by an embodiment of the present invention;

FIG. 6 is a schematic diagram of acquiring a first image provided by an embodiment of the present invention;

FIG. 7 is a schematic diagram of an image color display restoration method provided by another embodiment of the present invention;

FIG. 8 is a schematic diagram of acquiring an imaging parameter value of a camera device provided by an embodiment of the present invention; and

FIG. 9 is a schematic diagram of acquiring a display parameter value of a display device provided by an embodiment of the present invention.

### DETAILED DESCRIPTION OF PREFERRED EMBODIMENTS

The present invention is described particularly by the following examples, and these examples are for illustrative purposes only. For those skilled in the art, various changes and modifications can be made without departing from the spirit and scope of the disclosure, so the scope of protection of the disclosure shall be as defined in the appended claims. Throughout the specification and claims, unless the context clearly specifies otherwise, the meaning of “a” and “the” includes that such statements include “one or at least one” component or element. In addition, as used herein, the singular article also includes the statement of a plurality of components or elements unless it is apparent from the specific context that the plurality is excluded. Moreover, when applied in this description and all the claims below, the meaning of “on” may include “in” and “on” unless the context clearly specifies otherwise. Unless otherwise specified, the terms used throughout the specification and claims usually have the ordinary meaning of each term used in the art, in the contents disclosed here and in special contents. Some terms used to describe the present invention will be discussed below or elsewhere in this specification to provide the practitioner with additional guidance on the description of the present invention. The use of examples anywhere throughout this specification, including examples of any term discussed here, is for illustrative purposes only, and certainly does not limit the scope and meaning of the present invention or any exemplary term. Similarly, the present invention is not limited to the embodiments set forth in this specification.

The terms “substantially”, “around”, “about” or “approximately” used herein shall generally mean within 20%, preferably within 10%, of a given value or range. In addition, the quantities provided herein may be approximate, which means that unless otherwise stated, they can be expressed by the term “around”, “about” or “approximately”. When the quantity, concentration or other values or parameters have a specified range, a preferred range, or upper and lower ideal values listed, it shall be deemed as all ranges formed by any number pair or ideal values of the upper and lower limits specifically disclosed, whether these ranges are disclosed separately. For example, if a disclosed length ranges from X cm to Y cm, it should be deemed that the disclosed length is H cm and H may be any real number between X and Y.

In addition, if the word “coupled” or “connected” is used herein, it includes any direct and indirect electrical connection means. For example, if the first device is electrically coupled to the second device, it means that the first device may be directly connected to the second device, or indirectly connected to the second device through other devices or connecting means. In addition, if the transmission and provision of electrical signals are described, those skilled in the art should understand that the transmission process of electrical signals may be accompanied by attenuation or other non-ideal changes, but the source of transmission or provision and the receiving end of the electrical signal shall be substantially regarded as the same signal unless otherwise specified. For example, if a terminal A of an electronic circuit transmits (or provides) an electrical signal S to a terminal B of the electronic circuit, the electrical signal may go through the source and drain terminals of the transistor switch and/or the possible stray capacitance, causing a voltage drop. However, the purpose of this design is not to deliberately use the attenuation or other non-ideal changes generated during transmission (or provision) to achieve some specific technical effects, and the electrical signal S should be regarded as substantially the same signal at the terminal A and the terminal B of the electronic circuit.

It can be understood that the terms “comprising”, “including”, “having”, “containing”, “involving” and so on as used herein are open-ended, which means including but not limited to. In addition, it is not necessary for any embodiment or claim of the present invention to achieve all the objectives or advantages or characteristics disclosed in the present invention. In addition, the ABSTRACT section and title are merely intended to assist in searching patent documents and are not intended to limit the claims of the present invention.

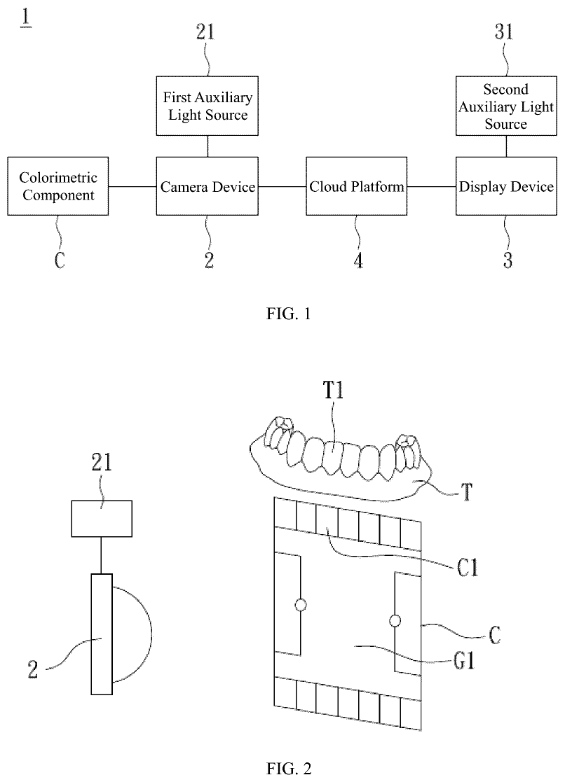

FIG. 1 is a block diagram of a color display restoration system provided by an embodiment of the present invention. The color display reduction system 1 provided by this embodiment includes a camera device 2, a display device 3, a cloud platform 4, a first auxiliary light source 21, a second auxiliary light source 31 and a colorimetric component C. The cloud platform 4 is coupled with the camera device 2 and the display device 3. For example, the camera device 2 is coupled to the cloud platform 4 by means of a computer, and the display device 3 is coupled to the cloud platform 4 by means of the computer. The colorimetric component C includes a plurality of color blocks C1 (for example, having different colors) and a hueless color block G1. The hueless color block G1 is a gray color, which has the following Lab values: a lightness (black/white) (L) of 70 to 90, a red/green value (a) of ±1.5, and a blue/yellow value (b) of ±1.5. Referring to FIG. 2, in this embodiment, the camera device 2 is used in a dental clinic. Before the dental clinic orders a denture for a patient, it is required to photograph teeth T in the patient's mouth first, so as to provide teeth T image data to the dental laboratory, so that the dental technician can make a denture that matches the patient's tooth color according to the teeth T image data. The camera device 2 (e.g., a camera, a mobile phone or another apparatus capable of recording visual images) provided by this embodiment is connected to the first auxiliary light source 21 to form an imaging environment. The camera device 2 acquires a first image and an imaging parameter value in the imaging environment. That is, the first image is obtained by the camera device 2 with the first auxiliary light source 21 (e.g., a flashlight). The first image may include a plurality of images. At least one of the plurality of images must include a physical object image (e.g., the teeth T image in the patient's mouth) and an image of the colorimetric component C, and the other images may only include the physical object image and not include the image of the colorimetric component. The image of the colorimetric component C at least includes an image of one of the plurality of color blocks C1 (the color block image at C1 in FIG. 2) and an image of the hueless color block G1. Further, the image data captured by the dental clinic include a set of data with both the physical object image and the image of the colorimetric component, and this set of data are obtained by photographing a target tooth T1 in the teeth T in the patient's mouth and the colorimetric component C at the same time by the camera device 2 with the first auxiliary light source 21 by the dental clinic. At this time, the medical worker in the dental clinic determines and selects one of the plurality of color blocks C1 on the colorimetric component C, for example, the color block at C1 in FIG. 2 (hereinafter referred to as “color block at C1” for convenience of explanation). The color of the color block at C1 is the closest to the color of the target tooth T1. Then, the color block at C1 in the colorimetric component C is aligned with (placed above, below, on the left of or on the right of) the target tooth T1, and imaging is performed by the camera device 2 with the first auxiliary light source 21. Specifically, lighting provided by the dental clinic (e.g., indoor lighting, outdoor lighting, etc.) is equivalent to an ambient light source. When a dental clinic worker (e.g., a dentist, a nurse practitioner or a related medical worker) captures the first image in the ambient light source, the color temperature of the first image may be influenced by the ambient light source, so it is necessary to reduce the influence of the ambient light source by the first auxiliary light source 21. The illumination of the first auxiliary light source 21 must be more than 2 times the illumination of the ambient light source, and a color temperature value of the first auxiliary light source 21 may be set according to the practical experience of those skilled in the art, for example, 6500 K. The imaging parameter value is also obtained by capturing a physical image (e.g., a dental model) and the colorimetric component C by the camera device 2 with the first auxiliary light source 21, so the imaging parameter value further includes a color temperature value, a capturing illumination value, parameter data of the colorimetric component C, the color temperature value of the first auxiliary light source 21, optical parameters of the camera device 2, etc., wherein the optical parameters of the camera device 2 may include, for example, aperture values, shutter speed values, focal length values, ISO sensitivity values, exposure compensation values, camera response function, etc.

Based on the above, in this embodiment, the cloud platform 4 receives the imaging parameter value, the first image and the display parameter value, and corrects the first image according to the imaging parameter value and the display parameter value, for example, correcting the color of the first image. The first image forms the second image after being corrected, and the cloud platform 4 outputs the second image. In other embodiments, the display parameter value may be obtained by measuring an inputted display correction image. For example, an L0-L255 16-order white image is inputted into the display device 3, and measured by an instrument to obtain color light components of the three primary colors of red, green and blue as a part of the Gamma value. Therefore, the display parameter value includes a display Gamma value, a display contrast value, a display brightness value, etc. In addition, the cloud platform 4 further receives data including the model of the camera device 2 and the model of the display device 3. Further, the cloud platform 4 receives data including the model of the camera device 2, the imaging parameter value, the model of the display device 3, the display parameter value and the first image, acquires color restoration information based on the acquired data by a color restoration algorithm, and performs color correction on the first image based on the color restoration information to form the color-corrected second image, and the cloud platform 4 outputs the second image to the display device 3. Besides, it should be noted that in this embodiment, data transmission between the camera device 2 and the cloud platform 4 and data transmission between the display device 3 and the cloud platform 4 are performed by non-distortion compression so as to avoid distortion of images in transmission.

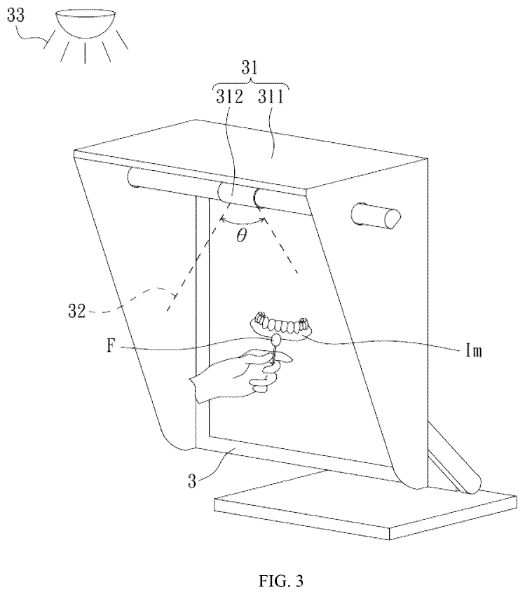

In this embodiment, the display device 3 is used in a dental laboratory. After the dental technician makes the denture F for the patient, it is necessary to compare whether there is a color difference between the denture F and the second image. The display device 3 provided in this embodiment is, for example, an advanced reflectionless technology display configured to display the second image. In addition, in this embodiment, a second auxiliary light source 31 is also included to be used together with the display device 3, so as to compare the second image with the denture F. The second image includes a physical object image, for example, the teeth T image in the patient's mouth shown in FIG. 2. Specifically, as shown in FIG. 3, lighting provided in the dental laboratory is equivalent to an ambient light source area 33, and the ambient light source area 33 has a first illumination value. The display device 3 is located in the ambient light source area 33. The display device 3 receives and displays the second image Im. When the dental technician compares the second image Im with the denture F in the ambient light source area 33, the color temperatures of the second image Im and the denture F may be influenced by the ambient light source, so it is necessary to reduce the influence of the ambient light source by the second auxiliary light source 31. The second auxiliary light source 31 is matched and arranged corresponding to the display device 3, and forms a light source control area 32 in front of a display surface of the display device 3, and the second auxiliary light source 31 has a second auxiliary light source parameter value including a second illumination value, which is more than 2 times the first illumination value. Besides, the color temperature value of the second auxiliary light source 31 is the same as the image color temperature value of the second image Im. In an embodiment, the color temperature value of the second auxiliary light source 31 is, for example, set to 6500 K. Further, a display panel of the display device 3 further includes a diffused reflection film used for increasing diffused reflection and reducing specular reflection, so that the reflection of ambient light by the display device 3 is close to the reflection of the ambient light by the physical object, thereby presenting a very natural sense of reality.

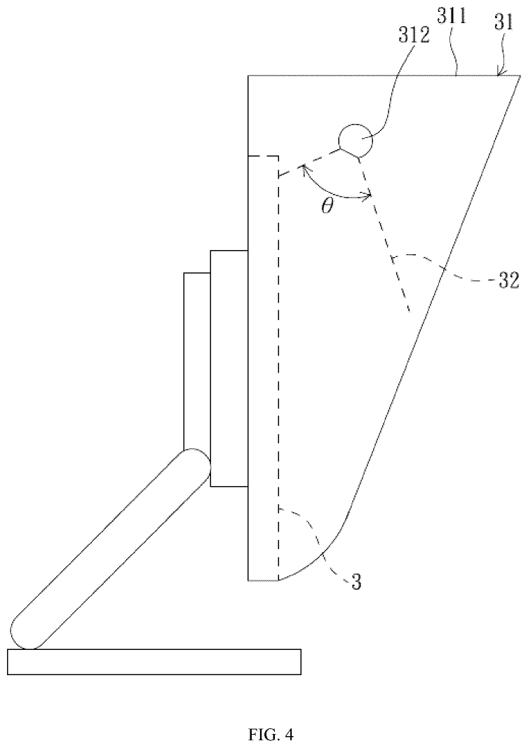

FIG. 3 is a schematic diagram of a second auxiliary light source provided by an embodiment of the present invention. In this embodiment, the second auxiliary light source 31 includes a light shield 311 and a light-emitting component 312, and the light-emitting component 312 is matched and assembled corresponding to the light shield 311. Specifically, the ambient light source comes from all directions, for example, it may be the light source from the door or window or the light source from the indoor lighting, so the light shield 311 is arranged around the display device 3 and extends to the front of the display surface of the display device 3 to shield the ambient light source, for example, the lighting lamp on the indoor ceiling, and the light-emitting component 312 is arranged in the light shield 311 and located above the display device 3 to irradiate the display device 3 from the top downwards so as to form a light source control area 32. Light in the light source control area 32 has an included angle θ with the display surface of the display device 3. The included angle θ ranges from 60° to 90°. In this embodiment, as shown in FIG. 4, the included angle θ is 60°. In other embodiments, the included angle θ may be 90°. Thereby, when the dental technician compares the second image Im with the denture, the influence of the ambient light source can be reduced.

In addition, in an embodiment, the present invention further provides a display system. The display system includes: a display device 3, located in an ambient light source area 33 having a first illumination value; and a second auxiliary light source 31, matched and arranged corresponding to the display device 3 and forming a light source control area 32. The second auxiliary light source 31 has a second illumination value. The second illumination value in the light source control area is more than 2 times the first illumination value. It should be noted that the functions performed by the display device 3 and the second auxiliary light source 31 are as described in the corresponding paragraphs and FIGS. 3 and 4 in the above embodiment, and thus will not be repeated here.

In addition, in an embodiment, the present invention further provides an image color display restoration system. The image color display restoration system includes a display device 3 and a cloud platform 4 (referring to FIG. 1). The cloud platform 4 is configured to receive a first image, an imaging parameter value and a display parameter value, and after correcting the first image according to the imaging parameter value and the display parameter value, output a second image Im. The display device 3 has the aforementioned display parameter value and provides the display parameter value to the cloud platform 4. The display device 3 receives and displays the second image Im under the setting of the above display parameter value. In addition, the first image includes a physical object image and an image of a colorimetric component, and the image of the colorimetric component includes at least one color block image and a hueless color block image. It should be noted that the functions performed by the display device 3 and the cloud platform 4 in this embodiment are as described in the corresponding paragraphs in the above embodiment, and thus will not be repeated here.

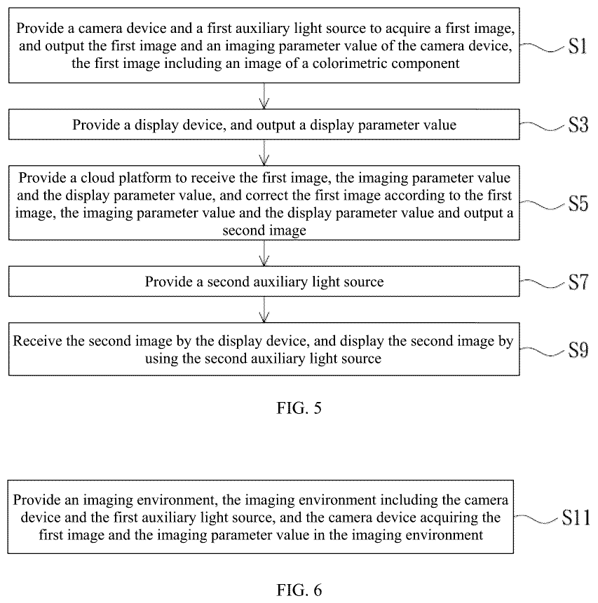

FIG. 5 is a schematic diagram of an image color display restoration method provided by an embodiment of the present invention. The image color display restoration method provided by this embodiment is applicable to the image color display restoration system 1 provided by the present invention. The image color display restoration method includes steps as follows (in this embodiment, step signs, such as S1, S3, . . . , are not limited in sequence, and are only used for illustration). Step S1: Provide a camera device 2 and a first auxiliary light source 21 to acquire a first image, and output the first image and an imaging parameter value of the camera device 3, the first image including an image of a colorimetric component. Step S3: Provide a display device 3, and output a display parameter value. Step S5: Provide a cloud platform 4 to receive the first image, the imaging parameter value and the display parameter value, and correct the first image according to the first image, the imaging parameter value and the display parameter value and output a second image. Step S7: Provide a second auxiliary light source 31. Step S9: Receive the second image by the display device 3, and display the second image by using the second auxiliary light source 31. In addition, it should be noted that the functions performed by the camera device 2, the display device 3, the cloud platform 4, the first auxiliary light source 21 and the second auxiliary light source 31 in this embodiment are as described in the corresponding paragraphs in the above embodiment, and thus will not be repeated here.

FIG. 6 is a schematic diagram of acquiring a first image provided by an embodiment of the present invention. Step S1 in the image color display restoration method further includes substep S11: provide an imaging environment, the imaging environment including the camera device 2 and the first auxiliary light source 21, and the camera device 2 acquiring the first image and the imaging parameter value in the imaging environment. In addition, it should be noted that the functions performed by the camera device 2 and the first auxiliary light source 21 in this embodiment are as described in the corresponding paragraphs in the above embodiment, and thus will not be repeated here.

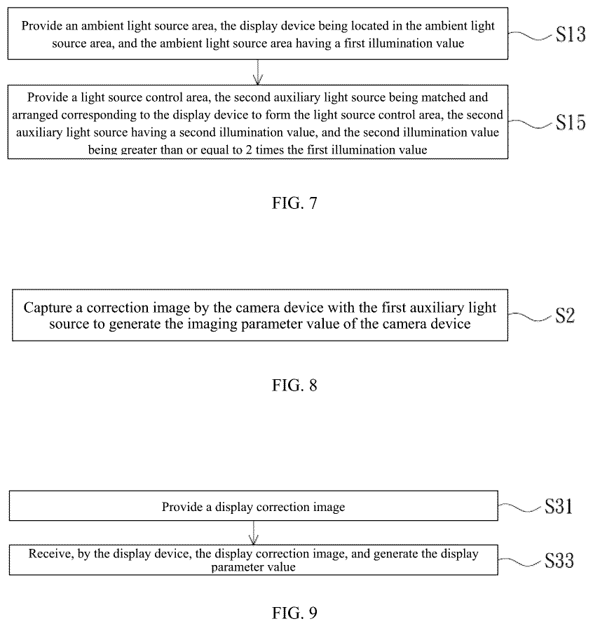

FIG. 7 is a schematic diagram of an image color display restoration method provided by another embodiment of the present invention. Compared with the image color display restoration method provided by the previous embodiment, in addition to steps S1, S3, S5, S7 and S9, the image color display restoration method provided by this embodiment further includes step S13: provide an ambient light source area 33, the display device 3 being located in the ambient light source area 33, and the ambient light source area 33 having a first illumination value; and substep S15: provide a light source control area 32, the second auxiliary light source 31 being matched and arranged corresponding to the display device 3 to form the light source control area 32, the second auxiliary light source 31 having a second illumination value, and the second illumination value being greater than or equal to 2 times the first illumination value. It should be noted that steps S1, S3, S5, S7 and S9 in the image color display restoration method provided by this embodiment that are the same as those in the image color display restoration method provided by the previous embodiment will not be illustrated and described in detail here, and only step S13 and step S15 will be illustrated and described here. The functions performed by the display device 3 and the second auxiliary light source 31 in this embodiment are as described in the corresponding paragraphs in the above embodiment, and thus will not be repeated here. In addition, it should be noted that in the steps in the image color display restoration method provided by this embodiment, step S13 is performed before step S9, and step S15 is performed between steps S7 and S9.

FIG. 8 is a schematic diagram of acquiring an imaging parameter value of a camera device provided by an embodiment of the present invention. In this embodiment, the flow of acquiring the imaging parameter value of the camera device 2 includes step S2: capture a correction image by the camera device 2 with the first auxiliary light source 21 to generate the imaging parameter value of the camera device 2. That is, the imaging parameter value of the camera device 2 is not limited to necessarily being acquired by capturing the first image by the camera device 2.

FIG. 9 is a schematic diagram of acquiring a display parameter value of a display device provided by an embodiment of the present invention. Step S3 in the image color display restoration method further includes substep S31: provide a display correction image; and step S33: receive, by the display device 3, the display correction image, and generate the display parameter value. That is, the display parameter value of the display device 3 may be additionally generated by displaying a display correction image, and is not necessarily the initial display parameter value of the display device 3.

Based on the above, according to the image color display restoration system and display system of the present invention, by means of parameter correction and setting with the colorimetric component, the auxiliary light sources, the camera device and the display device, the color can be automatically corrected, and the color difference of the denture can be reduced, and the color accuracy of the denture can be improved.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An image color display restoration system, comprising:
a colorimetric component, having a plurality of color blocks and a hueless color block;
a first auxiliary light source;
a camera device, connected to the first auxiliary light source to form an imaging environment, the camera device acquiring a first image and an imaging parameter value in the imaging environment, and the first image comprising an image of the colorimetric component;
a display device, located in an ambient light source area having a first illumination value, the display device having a display parameter value;
a second auxiliary light source, matched and arranged corresponding to the display device and forming a light source control area, the second auxiliary light source having a second illumination value; and
a cloud platform, coupled to the camera device and the display device, and configured to receive the first image, the imaging parameter value and the display parameter value, and after correcting the first image according to the imaging parameter value and the display parameter value, output a second image;
wherein the display device receives and displays the second image, and the second illumination value is greater than or equal to 2 times the first illumination value.

2. The image color display restoration system according to claim 1, wherein the light source control area is located in front of a display surface of the display device.

3. The image color display restoration system according to claim 1, wherein the first image further comprises a physical object image.

4. The image color display restoration system according to claim 1, wherein the second image comprises an image color temperature value, wherein the image color temperature value is the same as a color temperature value of the second auxiliary light source.

5. The image color display restoration system according to claim 1, wherein the second auxiliary light source comprises a light shield and a light-emitting component, and the light-emitting component is matched and assembled corresponding to the light shield.

6. The image color display restoration system according to claim 5, wherein the light shield is arranged around the display device and extends to the front of the display surface of the display device.

7. The image color display restoration system according to claim 5, wherein the light-emitting component is arranged in the light shield and located above the display device to form the light source control area, wherein light in the light source control area has an included angle with the display surface of the display device.

8. The image color display restoration system according to claim 7, wherein the included angle is 60° to 90°.

9. The image color display restoration system according to claim 1, wherein the imaging parameter value further comprises a color temperature value.

10. The image color display restoration system according to claim 1, wherein the display parameter value comprises a display Gamma value, a display contrast value and a display brightness value.

11. The image color display restoration system according to claim 1, wherein the hueless color block is a gray color, and the gray color has the following Lab values: a lightness of 70 to 90, a red/green value of ±1.5, and a blue/yellow value of ±1.5.

12. A display system, comprising:
a display device, located in an ambient light source area having a first illumination value; and
a second auxiliary light source, matched and arranged corresponding to the display device and forming a light source control area, the second auxiliary light source having a second illumination value;
wherein the second illumination value in the light source control area is more than 2 times the first illumination value.

13. The display system according to claim 12, wherein the second auxiliary light source comprises a light shield and a light-emitting component, and the light-emitting component is matched and assembled corresponding to the light shield.

14. The display system according to claim 13, wherein the light shield is arranged around the display device and extends to the front of the display surface of the display device.

15. The display system according to claim 14, wherein the light-emitting component is arranged in the light shield and located above the display device to form the light source control area, wherein light in the light source control area incident to the display surface of the display device forms an included angle.

16. The display system according to claim 15, wherein the included angle is 60° to 90°.

17. An image color display restoration system, comprising:
a display device, having a display parameter value; and
a cloud platform, receiving a first image, an imaging parameter value and the display parameter value, and after correcting the first image according to the imaging parameter value and the display parameter value, outputting a second image;
wherein the display device receives and displays the second image under the display parameter value, the first image comprises a physical object image and an image of a colorimetric component, and the image of the colorimetric component comprises at least one color block image and a hueless color block image.

18. The image color display restoration system according to claim 17, wherein the hueless color block image is a gray color, and the gray color has the following Lab values: a lightness of 70 to 90, a red/green value of ±1.5, and a blue/yellow value of ±1.5.

19. The image color display restoration system according to claim 17, wherein the display parameter value and the imaging parameter value both comprise parameter data of the image of the colorimetric component.

20. The image color display restoration system according to claim 17, wherein the image color display restoration system further comprises a first auxiliary light source, and the imaging parameter value comprises a color temperature value of the first auxiliary light source.

21. The image color display restoration system according to claim 17, wherein the image color display restoration system further comprises a second auxiliary light source, and the second auxiliary light source has a second illumination value.

22. The image color display restoration system according to claim 21, wherein the second auxiliary light source is matched and arranged corresponding to the display device and forms a light source control area.

23. The image color display restoration system according to claim 22, wherein the image color display restoration system comprises an ambient light source area having a first illumination value and matched and arranged corresponding to the display device, wherein the first illumination value is smaller than ½ of the second illumination value.

24. An image color display restoration method, comprising:
providing a camera device and a first auxiliary light source to acquire a first image, and outputting the first image and an imaging parameter value of the camera device, the first image comprising an image of a colorimetric component;
providing a display device, and outputting a display parameter value;
providing a cloud platform to receive the first image, the imaging parameter value and the display parameter value, and correcting the first image according to the first image, the imaging parameter value and the display parameter value and outputting a second image;
providing a second auxiliary light source; and
receiving the second image by the display device, and displaying the second image on the display device by using the second auxiliary light source.

25. The image color display restoration method according to claim 24, further comprising:
capturing a correction image by the camera device with the first auxiliary light source to generate the imaging parameter value of the camera device.

26. The image color display restoration method according to claim 24, further comprising:
providing a display correction image; and
receiving, by the display device, the display correction image, and generating the display parameter value.

27. The image color display restoration method according to claim 24, further comprising:
providing an imaging environment, the imaging environment comprising the camera device and the first auxiliary light source, and the camera device acquiring the first image and the imaging parameter value in the imaging environment.

28. The image color display restoration method according to claim 24, further comprising:
providing an ambient light source area, the display device being located in the ambient light source area, and the ambient light source area having a first illumination value.

29. The image color display restoration method according to claim 28, further comprising:
providing a light source control area, the second auxiliary light source being matched and arranged corresponding to the display device to form the light source control area, the second auxiliary light source having a second illumination value, and the second illumination value being greater than or equal to 2 times the first illumination value.

30. The image color display restoration method according to claim 29, wherein the light source control area is located in front of a display surface of the display device.

31. The image color display restoration method according to claim 24, wherein the first image comprises a physical object image.

32. The image color display restoration method according to claim 24, wherein the second image comprises an image color temperature value, wherein the image color temperature value is the same as a color temperature value of the second auxiliary light source.

33. The image color display restoration method according to claim 24, wherein the imaging parameter value further comprises a color temperature value.

34. The image color display restoration method according to claim 24, wherein the display parameter value comprises a display Gamma value, a display contrast value and a display brightness value.
